(19) United States
(12) Patent Application Publication
(10) Pub. No.: US 2023/0329369 A1
(43) Pub. Date: Oct. 19, 2023

(54) MASK

(71) Applicant: Gator Cases, Inc., Tampa, FL (US)

(72) Inventor: Dana M. Reese, Tampa, FL (US)

(21) Appl. No.: 18/028,087

(22) PCT Filed: Sep. 24, 2021
(86) PCT No.: PCT/US21/52064

§ 371 Date: Mar. 23, 2023

Related U.S. Application Data
(60) Provisional application No. 63/083,585, filed on Sep. 25, 2020.

(51) Int. Cl. A41D 13/11

(52) U.S. Cl. CPC A41D 13/113

(57) ABSTRACT

A face mask that has a first layer configured to be positioned adjacent to a user's face, an opening defined in the first layer, the opening configured to be positioned at least partially over a user's mouth, and a second layer positioned to selectively cover the opening defined in the first layer. The second layer is movable relative to the first layer to expose the opening.

### CROSS-REFERENCE TO RELATED APPLICATIONS

This disclosure is a national phase entry of International Application No. PCT/US21/52064 filed Sep. 24, 2021 and claims the benefit of U.S. Provisional Application No. 63/083,585 filed on Sep. 25, 2020, the contents of which are hereby incorporated herein in entirety.

### FIELD OF THE DISCLOSURE

The present disclosure relates to a face mask intended to cover the mouth and nose of a user, and more particularly, a face mask that has a movable flap that provides access to the user's mouth.

### BACKGROUND

Face masks are routinely used to filter air inhaled or exhaled by a user. Typical face masks entirely cover the user's mouth and nose in order to filter the surrounding air. A typical face mask wraps around the user's ears or head to keep the mask properly positioned over the user's nose and mouth. With a typical face mask, a user must substantially remove the face mask from at least one of the user's ears or the user's head in order to provide access to the user's mouth.

This process can be difficult to routinely execute in situations where the user needs intermittent access to their mouth. For example, if a user is eating or drinking, the user may only want to momentarily expose their mouth to eat or drink and quickly cover their mouth once they are done. Similarly, a user playing an instrument that requires access to the user's mouth may need to routinely expose their mouth to play the instrument. In these situations, removing the mask from the intended configuration around the user's ears or head may be difficult, take too long, and be uncomfortable. Accordingly, there is a need for a face mask that selectively provides easy and quick access to the user's mouth without requiring the face mask to be substantially removed.

### SUMMARY

The face mask design presented herein easily allows a wearer to drink, eat, or play musical instruments while never removing the mask. One embodiment of the mask comprises a top layer of fabric with two magnets on the bottom corners and two magnetic plates where the bridge of the nose sits. In this embodiment, the bottom layer of fabric has a cutout where the wearer's mouth is located and two more magnetic plates on each side of their chin. The mask has two string loops on either side which can be adjusted for better fitment around the wearer's ears.

In use of this embodiment, the wearer places the mask on the front of their face covering their nose and mouth. They then cinch the loop straps securely in place around their ears. To open the mask, they lift the bottom edge of the top layer of fabric folding upward until the magnets catch the magnetic plates near the nose. To close the mask, they pull the corner of the top layer of fabric downward and unfold the fabric towards the chin until the magnets are again secure against the magnetic plates near the chin.

One embodiment of this disclosure provides for a magnetic closed position and a magnetic opened position. While magnets are specifically discussed herein, the face mask may alternatively include snaps, zippers, hook and loop, separable adhesive strips or other fastening means to maintain the closed position or the opened position of the top layer. The face mask of this disclosure facilitates playing a musical instrument that involves the mouth while wearing the mask. Additionally, the face mask also facilitates the ability for an individual to drink or eat while wearing the mask.

In one aspect of this embodiment, the design of the face mask provides for the expedited positioning between the closed position and the opened position for exposing the mouth. The facemask provides the ability to secure the opening in the open position to play a musical instrument, and then close the opening securely quickly and efficiently—allowing the musician to focus on the music, and keep secure when not playing.

One embodiment is a face mask that has a first layer configured to be positioned adjacent to a user's face, an opening defined in the first layer, the opening configured to be positioned at least partially over a user's mouth, and a second layer positioned to selectively cover the opening defined in the first layer. The second layer is movable relative to the first layer to expose the opening.

One example of this embodiment has a coupling device on the second layer to selectively hold the second layer in a closed orientation. Part of this example has a first coupling receiver in the first layer that selectively receives the coupling device when the first layer is in the closed orientation. Another part of this example has a second coupling receiver that selectively receives the coupling device when the second layer is in an opened orientation.

Yet another example of this embodiment has a magnetic coupling device in the first layer or the second layer. Part of this example has a first magnetic receiver in the first layer or the second layer, wherein the magnetic coupling device selectively couples to the magnetic receiver. Further, the magnetic coupler and magnetic receiver are positioned to selectively hold the second layer in an opened configuration. Another part of this example has a second magnetic receiver in the first layer or the second layer, wherein the magnetic coupling device selectively couples the second magnetic receiver to hold the second layer in an opened configuration.

In yet another example of this embodiment the first layer comprises a chin saddle configured to be positioned on or under the chin of a user. Another example has a tag pocket defined along a seam of the face mask, wherein a tag is positioned along the tag pocket and transitionable between an exposed position extending away from the tag pocket and a hidden position wherein the tag is substantially contained within the pocket. In yet another example, the second layer contains distal end with a nose profile, wherein the nose profile substantially matches a profile of an upper seam of the first layer when in an opened position. In another example, the second layer is coupled to the first layer such that it cannot extend upwardly past a first layer perimeter. In yet another example, the first layer is sized to substantially cover the user's nose.

In another example of this embodiment, the first layer is formed from a first side and a second side coupled to one another along a substantially central seam. In part of this example, the second layer is formed from a first side and a second side coupled to one another along a seam that is substantially aligned with the central seam.

In one example of this embodiment, the second layer has one or more magnet positioned therein to selectively couple to a magnetized material in the first layer. In part of this example, both the one or more magnet and the magnetized material are substantially positioned within a cavity of the corresponding material such that neither the magnet or the magnetized material are visible from the outside.

Another embodiment is a method for manufacturing a face mask. The method includes providing a first layer sized to be positioned adjacent to a user's face and defining an opening at around the location of the user's mouth, coupling a second layer to the first layer to selectively cover the opening defined in the first layer, attaching a coupling device to the second layer and a first coupling receiver to the first layer to selectively hold the second layer in a closed orientation over the opening.

One example of this embodiment includes attaching a second coupling receiver to one or both of the first layer and second layer to selectively receive the coupling device when the second layer is in an opened orientation. Another example includes coupling the second layer to the first layer such that it cannot extend upwardly past a first layer perimeter.

### BRIEF DESCRIPTION OF THE FIGURES

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is an elevated perspective view of one embodiment of a face mask on a user and having a moveable second layer in a closed orientation;

FIG. 2 is an elevated perspective view of the face mask of FIG. 1 in an opened orientation;

FIG. 3 is a front view of the face mask of FIG. 1 on a user in the closed orientation; and

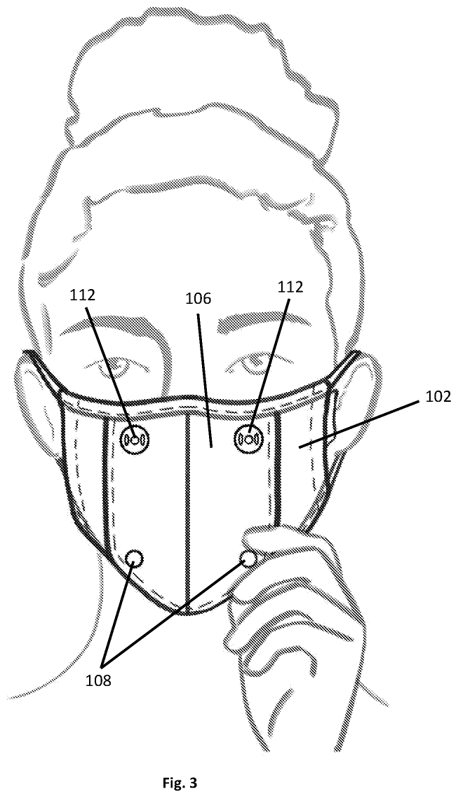

FIG. 4 a front view of the face mask of FIG. 1 on a user in the opened orientation.

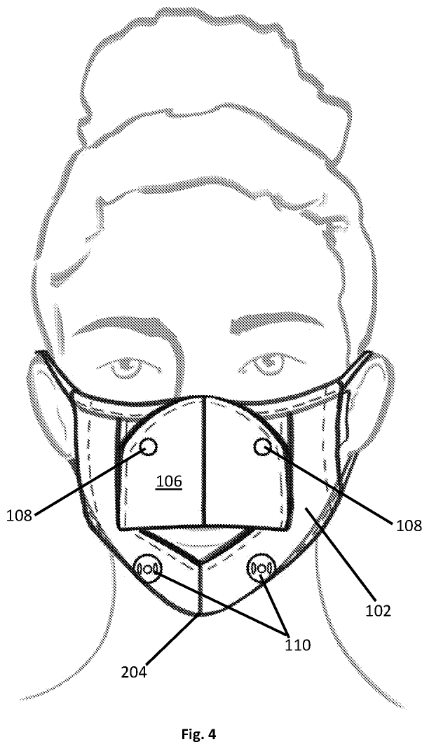

Corresponding reference numerals are used to indicate corresponding parts throughout the several views. It should be understood that the drawings are not necessarily to scale and that the disclosed embodiments are sometimes illustrated diagrammatically and in partial views. In certain instances, details which are not necessary for an understanding of the disclosed methods and devices or which render other details difficult to perceive may have been omitted. It should be further understood that this disclosure considers embodiments not specifically illustrated herein.

### DETAILED DESCRIPTION

For the purposes of promoting an understanding of the principles of the present disclosure, reference will now be made to the embodiments described herein and illustrated in the drawings and specific language will be used to describe the same. It will nevertheless be understood that no limitation of the scope of the present disclosure is thereby intended, such alterations and further modifications in the illustrated devices and methods, and such further applications of the principles of the present disclosure as illustrated therein being contemplated as would normally occur to one skilled in the art to which the present disclosure relates.

The terminology used herein is for the purpose of describing particular embodiments only and is not intended to be limiting of any embodiment. As used herein, the singular forms “a,” “an” and “the” are intended to include the plural forms as well, unless the context clearly indicates otherwise. It will be further understood that the terms “includes”, “comprises”, “including” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. As used herein, the term “and/or” includes any and all combinations of one or more of the associated listed items. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Unless specifically stated or obvious from context, as used herein, the term “about” in reference to a number or range of numbers is understood to mean the stated number and numbers +/−10% thereof, or 10% below the lower listed limit and 10% above the higher listed limit for the values listed for a range.

Throughout this disclosure, various quantities, such as amounts, sizes, dimensions, proportions and the like, are presented in a range format. It should be understood that the description of a quantity in range format is merely for convenience and brevity and should not be construed as an inflexible limitation on the scope of any embodiment. Accordingly, the description of a range should be considered to have specifically disclosed all the possible subranges as well as all individual numerical values within that range unless the context clearly dictates otherwise. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual values within that range, for example, 1.1, 2, 2.3, 4.62, 5, and 5.9. This applies regardless of the breadth of the range. The upper and lower limits of these intervening ranges may independently be included in the smaller ranges, and are also encompassed within the disclosure, subject to any specifically excluded limit in the stated range. Where the stated range includes one or both of the limits, ranges excluding either or both of those included limits are also included in the disclosure, unless the context clearly dictates otherwise.

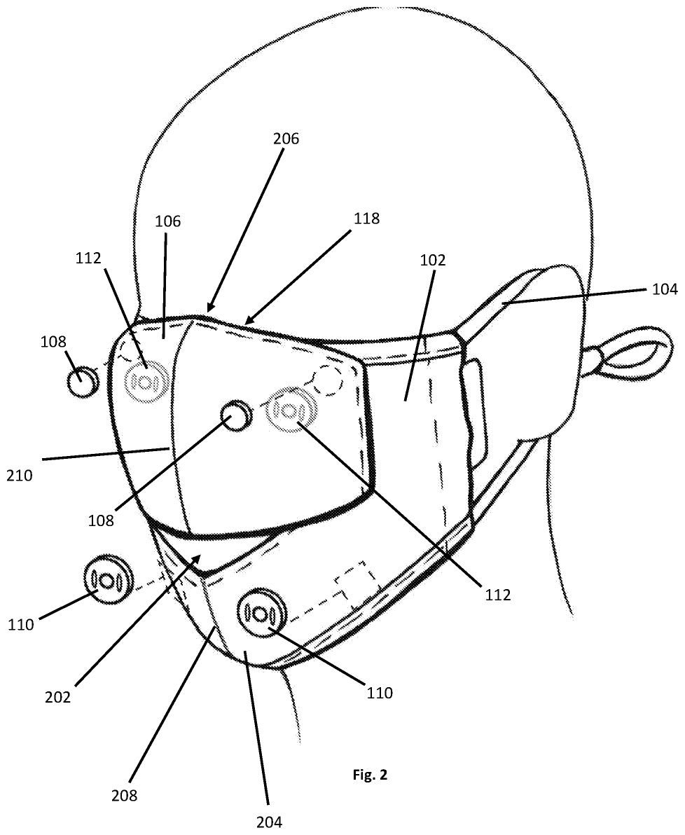

One embodiment of this disclosure is a face mask 100 having a first layer 102 sized to be positioned adjacent to a user's face to cover the user's nose. The first layer 102 may have an opening 202 (see FIG. 2) that is positioned around the user's mouth and selectively covered by a second layer 106. The first layer 102 may be coupled around the ears of the user with an ear strap 104 on either side of the face mask 100. In this configuration, the user may positioned the first layer 102 to substantially cover the user's nose with the opening 202 around the user's mouth. The ear straps 104 may hold the face mask 100 in the desired orientation on the user's face.

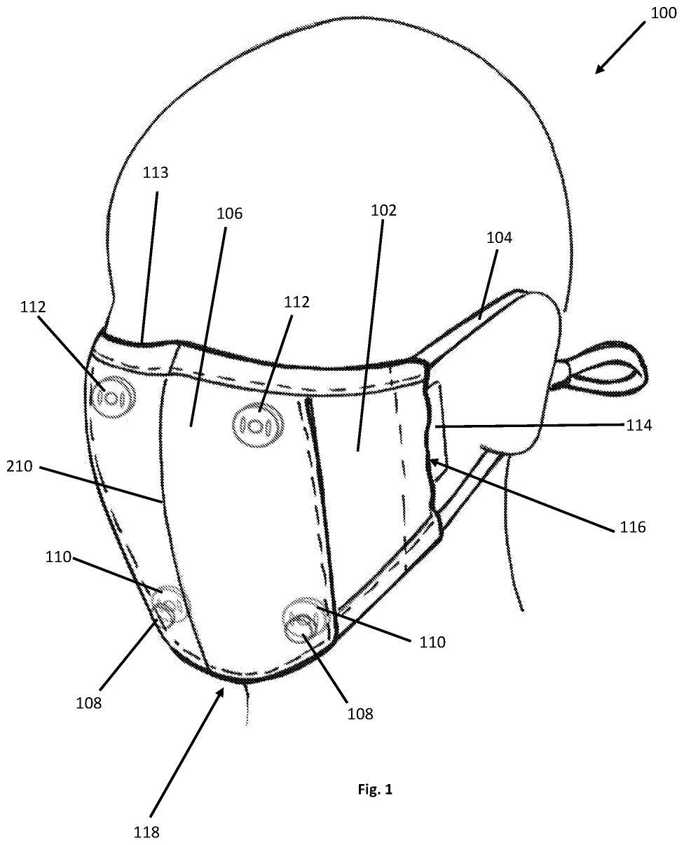

The second layer 106 may have a closed configuration, as illustrated in FIG. 1, wherein the second layer 106 substantially covers the opening 202 in the first layer 102. In the closed configuration, the user's nose and mouth may be substantially protected from the surrounding environment. Further, in the closed configuration the first and second layer 102, 106 may filter air being exchanged between the user's nose and mouth and the surrounding environment. Accordingly, when the second layer 106 is in the closed configuration, the face mask 100 is substantially filtering air exchanged between the user and the surrounding environment.

The face mask 100 may have one or more coupling device 108 in, or on, the second layer 106. The coupling device 108 may be configured to selectively hold the second layer 106 in the closed configuration. In one aspect of this disclosure, the coupling device 108 may have a coupling receiver 110 defined in or on the first layer 102. In this configuration, the coupling device 108 may be selectively coupled to the coupling receiver 110 to hold the second layer 106 in the closed configuration. In one example of this disclosure, the coupling device 108 is a magnet and the coupling receiver 110 is a magnetizable material such as steel or the like. In another example contemplated herein, the coupling device 108 and the coupling receiver 110 may be corresponding snaps. In yet another aspect of this disclosure, the coupling device 108 and coupling receiver 110 may be hook and loop fasteners. Accordingly, any known device for coupling two components to one another is contemplated herein for the coupling device 108 and coupling receiver 110.

A second coupling receiver 112 may be positioned towards an upper seam 113 of the face mask 100. The second coupling receiver 112 may be configured to engage the coupling device 108 to substantially maintain the second layer 106 in the opened configuration as illustrated in FIG. 2. The second coupling receiver 112 may be substantially the same as the first coupling receiver 110. For example, when the coupling device 108 is a magnet, the second coupling receiver 112 may be a magnetizable material such as steel. Alternatively, the second coupling receiver 112 may be a snap, or hook and loop fastener, to correspond with a similar fastener of the coupling device 108.

In one example of this disclosure, one or both of the first layer 102 and the second layer 106 may be formed from multiple layers of material sewn or otherwise coupled to one another. Further, the coupling device 108 may be a magnet that is between layers of the second layer 106 such that the coupling device 108 is not visible. In this configuration, the magnet of the coupling device 108 may be sewn into position between the multiple layers of material in the second layer 106. Similarly, the coupling receiver 110 may be a magnetizable material sewn between layers of material for the first layer 102. Further, the coupling receiver 112 may also be a magnetizable material sewn between layers of the first layer 102, the second layer 106, or between the first layer 102 and the second layer 106. Regardless, the coupling device 108 may be magnetically maintained in either the closed position of FIG. 1 or the opened position of FIG. 2 through magnetic attraction between the coupling device 108 and the corresponding coupling receiver 110, 112.

While the coupling device 108 and coupling receivers 110, 112 are illustrated as visible in the figures presented herein, these components 108, 110, 112 may be substantially hidden between layers of material as discussed herein. Alternatively, these components 108, 110, 112 may be sewn to the surface of a corresponding layer 102, 106. Accordingly, many different configurations for the components 108, 110, 112 are contemplated herein.

In one aspect of this disclosure, the second layer 106 may have a coupling device 108 on either side of a substantially central seam 210. Further, there may be two coupling receivers 110 to correspond with the two coupling devices 108 to hold the second layer in the closed configuration. Similarly, there may be two coupling receivers 112 to correspond with the coupling device 108 to hold the second layer in the opened configuration as well. While two coupling devices 108 and two of each coupling receivers 110, 112 are illustrated herein, in other embodiments only a single central coupling device 108 is positioned in the second layer 106 to correspond with a single coupler receiver 110 and coupling receiver 112. Alternatively, this disclosure also contemplates using more than two coupling devices and corresponding coupling receivers to achieve the selectable opened and closed configurations disclosed herein.

With referenced to FIG. 2, a chin saddle 204 is illustrated formed in the first layer 102. The chin saddle 204 may be sized to be positioned partially around, or on, the chin of the user. The chin saddle 204 may have a pocket defined therein to substantially maintain a position of the first layer 102 along the chin of a user when the ear straps 104 are positioned around the user's ears and the face mask 100 is covering the user's nose. When the chin saddle 204 is properly covering the user's chin, the opening 202 may be aligned with the user's mouth and the first layer 102 may be covering the user's nose.

In one aspect of this disclosure, the first layer 102 is formed from a first side and a second side coupled to one another along a substantially central seam 208. The central seam 208 may provide a location that allows the chin saddle 204 to be formed during manufacturing. Similarly, the second layer 106 may have a seam 210 separating a first side and a second side. The central seam 208 of the first layer 102 and the seam 210 of the second layer 106 may substantially align with one another. Further, the seam 210 in the second layer 106 may allow the second layer 106 to be formed with a contour. The contour may be partially reversibly concave depending on whether the second layer 106 is in the opened or closed configuration and provide a profile that allows the second layer 106 to bend over the user's nose and mouth in the closed position and bend over the user's nose in the opened position.

In the opened configuration illustrated in FIG. 2, the second layer 106 may extend upwardly towards a first layer perimeter 206. The first layer perimeter 206 may be the portion of the first layer 102 that is configured to be positioned over the user's nose and underneath the user's eyes. The second layer 106 may have a distal nose profile 118 that substantially matches, or does not pass, the first layer perimeter 206 when in the opened configuration. In one aspect of this disclosure, the second layer 106 is coupled to the first layer 102 such that the second layer 106 cannot extend upwardly past the first layer 102 to interfere with the user's vision.

In another aspect of this disclosure, the first layer 102 may have a tag 114 coupled to a seam between connection points for the ear loops 104. The tag 114 may be coupled to the first layer adjacent to a tag pocket 116 defined in the first layer 102. The tag 114 may be sized to extend past the tag pocket 116 in an extended position but be configured to be tuckable within the tag pocket 116 to substantially hide the tag 114 in a retracted position.

While an exemplary embodiment incorporating the principles of the present application has been disclosed hereinabove, the present application is not limited to the disclosed embodiments. Instead, this application is intended to cover any variations, uses, or adaptations of the application using its general principles. Further, this application is intended to cover such departures from the present disclosure as come within known or customary practice in the art to which this present application pertains and which fall within the limits of the appended claims.

What is claimed is:

1. A face mask, comprising:
a first layer configured to be positioned adjacent to a user's face;
an opening defined in the first layer, the opening configured to be positioned at least partially over a user's mouth; and
a second layer positioned to selectively cover the opening defined in the first layer;
wherein, the second layer is movable relative to the first layer to expose the opening.

2. The face mask of claim 1, further comprising a coupling device on the second layer to selectively hold the second layer in a closed orientation.

3. The face mask of claim 2, further comprising a first coupling receiver in the first layer that selectively receives the coupling device when the first layer is in the closed orientation.

4. The face mask of claim 3, further comprising a second coupling receiver that selectively receives the coupling device when the second layer is in an opened orientation.

5. The face mask of claim 1, further comprising a magnetic coupling device in the first layer or the second layer.

6. The face mask of claim 5, further comprising a first magnetic receiver in the first layer or the second layer, wherein the magnetic coupling device selectively couples to the magnetic receiver.

7. The face mask of claim 6, wherein the magnetic coupler and magnetic receiver are positioned to selectively hold the second layer in a closed configuration.

8. The face mask of claim 7, further comprising a second magnetic receiver in the first layer or the second layer, wherein the magnetic coupling device selectively couples the second magnetic receiver to hold the second layer in an opened configuration.

9. The face mask of claim 1, wherein the first layer comprises a chin saddle configured to be positioned on or under the chin of a user.

10. The face mask of claim 1, further comprising a tag pocket defined along a seam of the face mask, wherein a tag is positioned along the tag pocket and transitionable between an exposed position extending away from the tag pocket and a hidden position wherein the tag is substantially contained within the pocket.

11. The face mask of claim 1, further wherein the second layer contains distal end with a nose profile, wherein the nose profile substantially matches a profile of an upper seam of the first layer when in an opened position.

12. The face mask of claim 1, wherein the second layer is coupled to the first layer such that it cannot extend upwardly past a first layer perimeter.

13. The face mask of claim 1, wherein the first layer is sized to substantially cover the user's nose.

14. The mask of claim 1, wherein the first layer is formed from a first side and a second side coupled to one another along a substantially central seam.

15. The mask of claim 14, wherein the second layer is formed from a first side and a second side coupled to one another along a seam that is substantially aligned with the central seam.

16. The mask of claim 1, wherein the second layer has one or more magnet positioned therein to selectively couple to a magnetized material in the first layer.

17. The mask of claim 16, wherein both the one or more magnet and the magnetized material are substantially positioned within a cavity of the corresponding material such that neither the magnet or the magnetized material are visible from the outside.

18. A method for manufacturing a face mask, comprising:
providing a first layer sized to be positioned adjacent to a user's face and defining an opening at around the location of the user's mouth;
coupling a second layer to the first layer to selectively cover the opening defined in the first layer;
attaching a coupling device to the second layer and a first coupling receiver to the first layer to selectively hold the second layer in a closed orientation over the opening.

19. The method of claim 18, further comprising attaching a second coupling receiver to one or both of the first layer and second layer to selectively receive the coupling device when the second layer is in an opened orientation.

20. The method of claim 18, further comprising coupling the second layer to the first layer such that it cannot extend upwardly past a first layer perimeter.
